(19) United States
(12) Patent Application Publication
(10) Pub. No.: US 2015/0161541 A1
(43) Pub. Date: Jun. 11, 2015

(54) Processing and Routing Referrals

(71) Applicant: Bank of America Corporation, Charlotte, NC (US)

(72) Inventors: Patrick James Brennan, New York, NY (US); Colleen C. Milazzo, Barrington, RI (US); Amber D. Schmidlin, Jersey City, NJ (US); Nancine M. Vitale, Boynton Beach, FL (US)

(73) Assignee: Bank of America Corporation, Charlotte, NC (US)

(21) Appl. No.: 14/099,041

(22) Filed: Dec. 6, 2013

(51) Int. Cl. G06Q 10/06

(52) U.S. Cl. CPC G06Q 10/06311; G06Q 10/063114

(57) ABSTRACT

Methods and systems for processing and routing referrals, particularly referrals of customers between lines of business, subsidiaries, and other related entities of a large organization, such as a financial institution, are presented. In some embodiments, a computer system may receive a referral from a source system associated with a line of business of an organization. Based on receiving the referral, the computer system may enrich the referral by gathering available information about a customer associated with the referral. Subsequently, the computer system may identify a destination for the referral by processing the referral based on one or more business rules and one or more compliance requirements. The computer system then may route the referral to the identified destination. In some instances, gathering available information about the customer may include collecting internal information about the customer's existing relationship with the organization.

### BACKGROUND

Aspects of the disclosure relate to computer hardware and software. In particular, one or more aspects of the disclosure generally relate to computer hardware and software for processing and routing referrals.

Large organizations, such as financial institutions, may be made up of many internal lines of business, partially- and/or wholly-owned subsidiaries, and/or other related entities that may offer and provide various products and services to many different customers. In some instances, a customer of a large organization might only make use of a relatively small subset of the products and services offered by the organization, sometimes because the customer might now know about the other available products and services that are offered by the organization. As customers learn about these other available products and services, they may wish to be (and subsequently may request to be) referred to the other lines of business, subsidiaries, and/or other related entities that may offer and provide such products and services. It may be difficult, however, to refer a particular customer to an optimal person and/or team within the organization in an efficient and effective manner.

### SUMMARY

Aspects of the disclosure relate to various systems and techniques that provide effective, efficient, scalable, and convenient ways of processing and routing referrals, particularly referrals of customers between lines of business, subsidiaries, and other related entities of a large organization, such as a financial institution.

In particular, some aspects of the disclosure provide systems and methods that may allow cross-selling of various client services and other products, such as investment products and services that may be offered by a financial institution. In addition, some aspects of the disclosure provide features that may offer advantages over conventional ways of managing referrals, such as compliance features that may, in the context of a financial institution, for example, ensure that referrals are spread evenly among financial advisors.

In some arrangements discussed in greater detail below, various business rules that may be applicable to a particular referral may be evaluated, thereby ensuring that referrals are generally routed in the most appropriate and effective manner possible. In addition, the management and enforcement of various regulatory and compliance requirements may be automated, along with the management and enforcement of various internal policy requirements. Some aspects of the disclosure also provide for a componentized system and an agile process that allow the systems and methods discussed herein to be quickly and easily deployed and updated within an organization, thereby allowing these systems and methods to better adapt to changing business requirements.

Thus, in some embodiments discussed in greater detail below, a computer system may receive a referral from a source system associated with a line of business of an organization. Based on receiving the referral, the computer system may enrich the referral by gathering available information about a customer associated with the referral. Subsequently, the computer system may identify a destination for the referral by processing the referral based on one or more business rules and one or more compliance requirements. The computer system then may route the referral to the identified destination.

In some instances, the source system may be a customer relationship management (CRM) system used by the line of business in managing customer interactions. Additionally or alternatively, gathering available information about the customer may include collecting internal information about the customer's existing relationship with the organization.

In some instances, the identified destination may be an automated assignment system. In other instances, the identified destination may be a manual review team.

In some instances, after routing the referral to the identified destination, the computer system may track the referral. In some instances, tracking the referral may include reassigning the referral if a referral recipient does not contact the customer within a predetermined amount of time. Additionally or alternatively, tracking the referral may include maintaining expiration clock information associated with the referral. Additionally or alternatively, tracking the referral may include providing one or more status notifications to the source system. Additionally or alternatively, tracking the referral may include determining an amount of revenue generated by the referral.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A illustrates an example operating environment in which various aspects of the disclosure may be implemented;

FIG. 1B illustrates another example operating environment in which various aspects of the disclosure may be implemented;

FIG. 2 illustrates an example of a system for processing and routing referrals according to one or more aspects of the disclosure;

FIG. 3 illustrates a flowchart that depicts a method of processing and routing referrals according to one or more aspects of the disclosure;

FIG. 4 illustrates an example of a user interface that may be displayed in creating and/or receiving a referral according to one or more aspects of the disclosure; and

FIG. 5 illustrates an example of a user interface that may be displayed in routing a referral according to one or more aspects of the disclosure.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

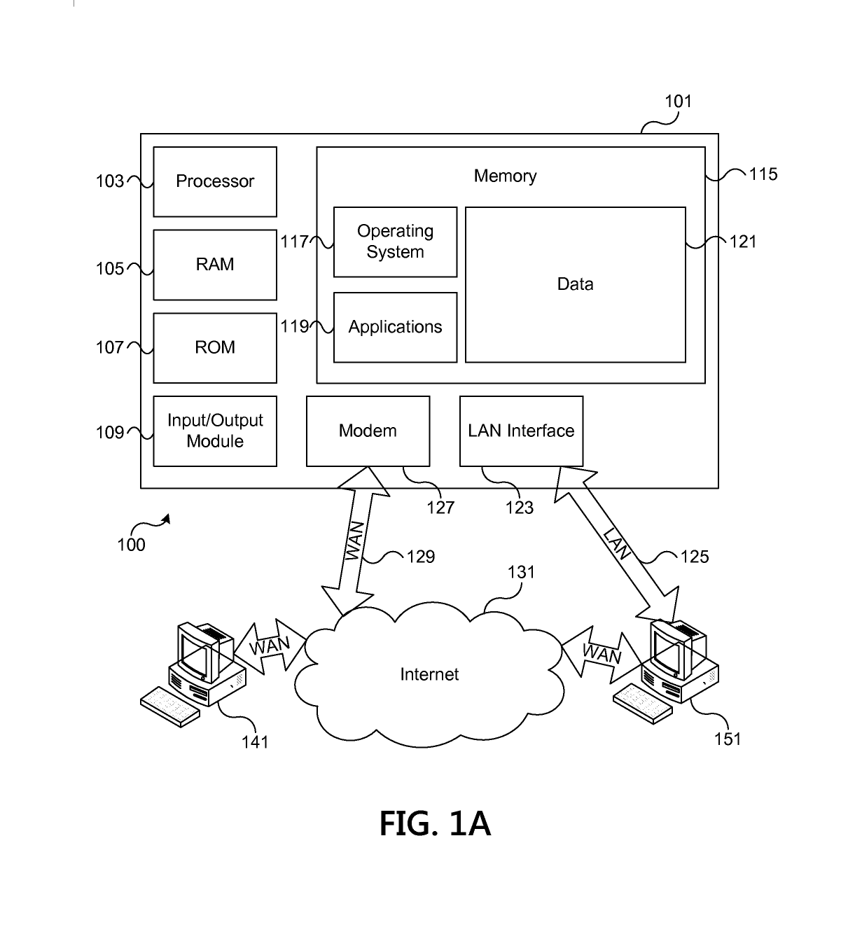

As noted above, certain embodiments are discussed herein that relate to processing and routing referrals. Before discussing these concepts in greater detail, however, an example of a computing device that can be used in implementing various aspects of the disclosure, as well as an example of an operating environment in which various embodiments can be implemented, will first be described with respect to FIGS. 1A and 1B.

FIG. 1A illustrates an example block diagram of a generic computing device 101 (e.g., a computer server) in an example computing environment 100 that may be used according to one or more illustrative embodiments of the disclosure. The generic computing device 101 may have a processor 103 for controlling overall operation of the server and its associated components, including random access memory (RAM) 105, read-only memory (ROM) 107, input/output (I/O) module 109, and memory 115.

I/O module 109 may include a microphone, mouse, keypad, touch screen, scanner, optical reader, and/or stylus (or other input device(s)) through which a user of generic computing device 101 may provide input, and may also include one or more of a speaker for providing audio output and a video display device for providing textual, audiovisual, and/or graphical output. Software may be stored within memory 115 and/or other storage to provide instructions to processor 103 for enabling generic computing device 101 to perform various functions. For example, memory 115 may store software used by the generic computing device 101, such as an operating system 117, application programs 119, and an associated database 121. Alternatively, some or all of the computer executable instructions for generic computing device 101 may be embodied in hardware or firmware (not shown).

The generic computing device 101 may operate in a networked environment supporting connections to one or more remote computers, such as terminals 141 and 151. The terminals 141 and 151 may be personal computers or servers that include many or all of the elements described above with respect to the generic computing device 101. The network connections depicted in FIG. 1A include a local area network (LAN) 125 and a wide area network (WAN) 129, but may also include other networks. When used in a LAN networking environment, the generic computing device 101 may be connected to the LAN 125 through a network interface or adapter 123. When used in a WAN networking environment, the generic computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Generic computing device 101 and/or terminals 141 or 151 may also be mobile terminals (e.g., mobile phones, smartphones, PDAs, notebooks, and so on) including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

FIG. 1B illustrates another example operating environment in which various aspects of the disclosure may be implemented. As illustrated, system 160 may include one or more workstations 161. Workstations 161 may, in some examples, be connected by one or more communications links 162 to computer network 163 that may be linked via communications links 165 to server 164. In system 160, server 164 may be any suitable server, processor, computer, or data processing device, or combination of the same. Server 164 may be used to process the instructions received from, and the transactions entered into by, one or more participants.

According to one or more aspects, system 160 may be associated with a financial institution, such as a bank. Various elements may be located within the financial institution and/or may be located remotely from the financial institution. For instance, one or more workstations 161 may be located within a branch office of a financial institution. Such workstations may be used, for example, by customer service representatives, other employees, and/or customers of the financial institution in conducting financial transactions via network 163. Additionally or alternatively, one or more workstations 161 may be located at a user location (e.g., a customer's home or office). Such workstations also may be used, for example, by customers of the financial institution in conducting financial transactions via computer network 163 or computer network 170.

Computer network 163 and computer network 170 may be any suitable computer networks including the Internet, an intranet, a wide-area network (WAN), a local-area network (LAN), a wireless network, a digital subscriber line (DSL) network, a frame relay network, an asynchronous transfer mode network, a virtual private network (VPN), or any combination of any of the same. Communications links 162 and 165 may be any communications links suitable for communicating between workstations 161 and server 164, such as network links, dial-up links, wireless links, hard-wired links, and/or the like.

Having described an example of a computing device that can be used in implementing various aspects of the disclosure and an operating environment in which various aspects of the disclosure can be implemented, several embodiments will now be discussed in greater detail. As introduced above, some aspects of the disclosure generally relate to processing and routing referrals, particularly referrals of customers between lines of business, subsidiaries, and/or other related entities of a large organization, such as a financial institution. In the discussion below, various examples illustrating how referrals can be received, processed, routed, and tracked in accordance with one or more embodiments will be provided.

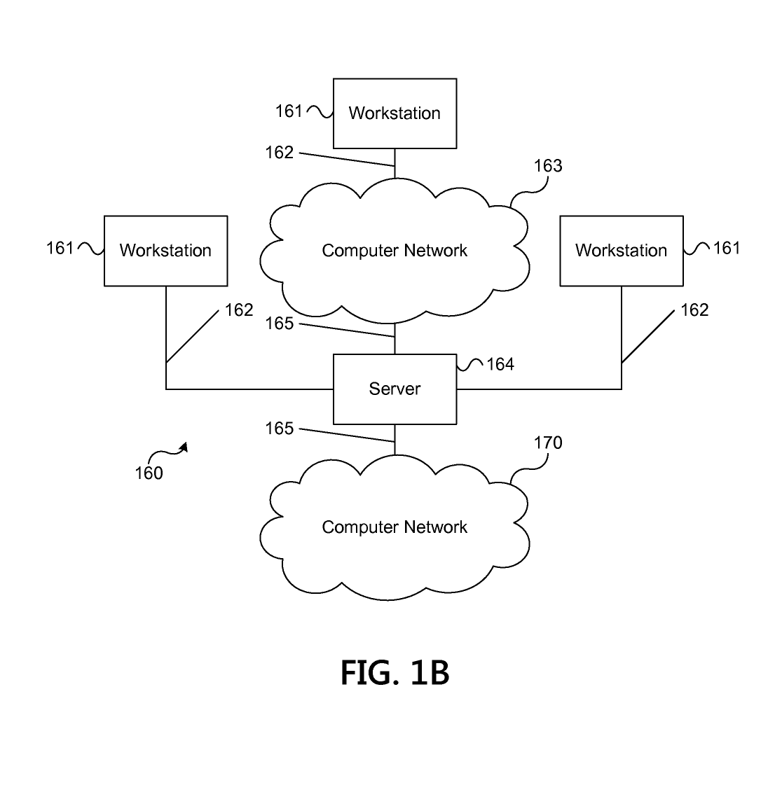

FIG. 2 illustrates an example of a system 200 for processing and routing referrals according to one or more embodiments. In some embodiments, system 200 may be implemented in one or more computing devices, which may include and/or incorporate one or more processors, one or more memories, and/or one or more aspects of the computing device 101 discussed above. In some instances, system 200 may include a number of different subsystems and/or databases. In some arrangements, all of the subsystems included in system 200 may be included in and/or incorporated into a single computing device, while in other arrangements, each subsystem included in system 200 (and/or combinations thereof) may be included in and/or incorporated into a distinct and/or dedicated computing device. In addition, each of the databases included in system 200 may be included in and/or incorporated into the same computing device as one or more other subsystems of system 200, or, in other arrangements, may be included in and/or incorporated into distinct and/or dedicated computing devices (which, e.g., are communicatively coupled to and/or otherwise accessible to system 200 and/or its various subsystems).

As seen in FIG. 2, in some embodiments, system 200 may include a referral receiving subsystem 205, a referral enriching subsystem 210, a referral processing subsystem 215, a referral routing subsystem 220, and a referral tracking subsystem 225. This arrangement represents one example configuration of system 200. In other embodiments, one or more elements of system 200 may be combined and/or additional and/or alternative subsystems may be included in addition to and/or instead of those shown in FIG. 2.

In some embodiments, referral receiving subsystem 205 may be configured to receive a referral from a source system associated with a line of business. For example, referral receiving subsystem 205 may receive information associated with a referral from another computer system that may, for instance, be used by, maintained by, and/or implemented for a particular line of business with the organization that may be deploying, implementing, and/or using system 200 to manage referrals.

In some embodiments, referral enriching subsystem 210 may be configured to enrich a referral (e.g., the referral received by referral receiving subsystem 205) by gathering information about a customer associated with the referral. Such information may, for instance, be stored in various databases that are included in and/or accessible to system 200, and referral enriching subsystem 210 may access and/or obtain this information to enrich the referral. In one or more arrangements, these databases may, for example, be maintained and/or used by the same line of business from which the referral was received, although in some instances, one or more of these databases may be maintained and/or used by different lines of business and/or other affiliates.

In some embodiments, referral processing subsystem 215 may be configured to identify a destination for a referral (e.g., the referral received by referral receiving subsystem 205 and enriched by referral enriching subsystem 210) by processing the referral. For example, referral processing subsystem 215 may process the referral based on one or more business rules and/or one or more compliance requirements that may be stored and/or maintained by referral processing subsystem 215 and that may be evaluated by referral processing subsystem 215 in processing the referral.

In some embodiments, referral routing subsystem 220 may be configured to route a referral (e.g., the referral received by referral receiving subsystem 205 and enriched by referral enriching subsystem 210) to a destination (e.g., the destination identified by referral processing subsystem 215). For example, referral routing subsystem 220 may transmit and/or otherwise provide information associated with the referral to one or more computer systems and/or one or more users of computer systems that may be identified by referral processing subsystem 215 as being the target destination(s) for a specific referral.

In some embodiments, referral tracking subsystem 225 may be configured to monitor the status of various referrals after they are routed. For example, referral tracking subsystem 225 may track a referral (e.g., the referral routed by referral routing subsystem 220) after the referral is routed to periodically monitor the status of the referral. In addition, the referral tracking subsystem 225 may be configured to generate various notifications and/or reports about the status of one or more referrals that may be tracked by referral tracking subsystem 225 and/or that may be otherwise managed by system 200.

As indicated above, these are examples of the subsystems, databases, and/or other elements that may be included in system 200 in some embodiments, as well as some of the functions that may be performed (e.g., by system 200 and its various subsystems). In other embodiments, additional and/or alternative subsystems, databases, and/or other elements may similarly be included, and/or other functions may be performed, in addition to and/or instead of those discussed above.

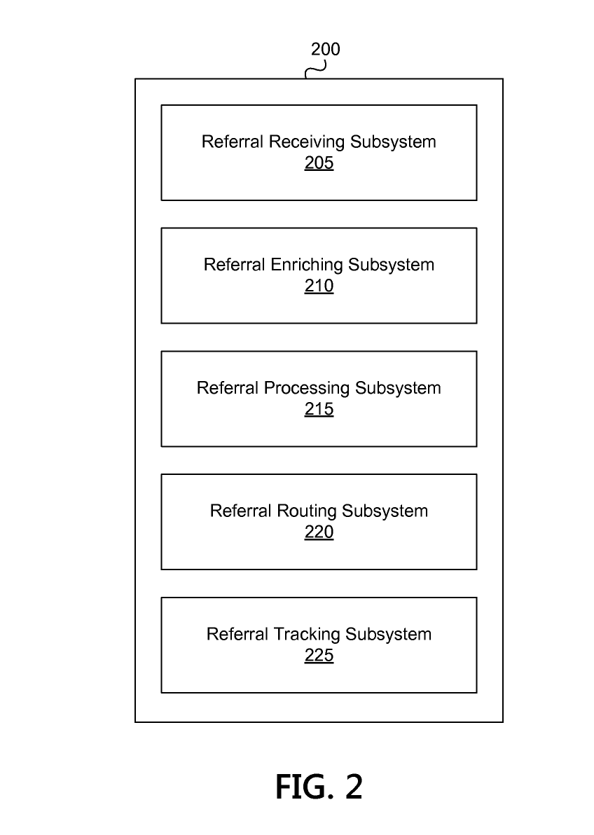

Having described an example system that may be used in processing and routing referrals in some embodiments, an example of a method that may, in some embodiments, be performed (e.g., by such a system 200; by another computing device, such as computing device 101; and/or the like) will now be discussed in greater detail with respect to FIG. 3.

FIG. 3 illustrates a flowchart that depicts a method of processing and routing referrals according to one or more aspects of the disclosure. In some embodiments, the example method illustrated in FIG. 3 may be performed by a computing device, which may include and/or implement one or more aspects of computing device 101. In additional and/or alternative embodiments, the example method illustrated in FIG. 3 may be performed by a computer system, such as a server computer system that is owned, operated, and/or controlled by a financial institution (which may, e.g., maintain the computer system in a back office or data center to process and route referrals), and such a computer system may include one or more computing devices that include and/or implement one or more aspects of computing device 101 and/or system 200. In other embodiments, the example method illustrated in FIG. 3 may be implemented in and/or may otherwise be embodied in computer-readable instructions that may be stored in a computer-readable medium, such as a memory.

As seen in FIG. 3, the method may be initiated in step 305, in which a referral may be received from a source system associated with a line of business of an organization. For example, in step 305, a computing device (e.g., computing device 101, system 200, and/or the like) may receive a referral from a source system associated with a line of business of an organization, which may be deploying and/or implementing the computing device for use in managing referrals.

In some embodiments, the referral may, for instance, include information identifying a customer who may have requested a transfer or recommendation to a specific line of business within the organization and/or otherwise associated with the organization. For example, the referral may include information identifying a customer who may have requested a transfer or recommendation to an investment services line of business from a consumer banking line of business or a home loans line of business. As another example, the referral may include information identifying a customer who may have requested a transfer or recommendation to a corporate retirement planning line of business from a small business banking line of business (e.g., in instances in which the customer requesting the referral is a corporate client instead of an individual client). In a typical instance, such a referral may be made at the request of the customer being transferred, recommended, and/or otherwise referred to another line of business. For example, the customer may be interacting with a first person, group, or system associated with the organization and may request contact with (and/or otherwise consent to being contacted by) a second person, group, or system associated with the organization. The second person, group, or system may be different from the first person, group, or system in that the second person, group, or system may, for instance, provide different products and/or services than the first person, group, or system. Additionally or alternatively, the second person, group, or system may be affiliated with a different line of business of the organization (e.g., an investment services line of business) than the first person, group, or system (which may, e.g., be affiliated with a consumer banking line of business).

In some embodiments, the source system may be a customer relationship management (CRM) system used by the line of business in managing customer interactions. For example, the computing device executing the method illustrated in FIG. 3 may integrate with one or more different CRM systems that each may be implemented for, used by, and/or maintained by a different line of business of the organization. As a result, different types of information may be received by the computing device in step 305 in connection with different referrals, depending on the source system(s) and the source line(s) of business of the referrals. In some instances, the computing device may receive a referral (e.g., in step 305) simply as user input. For example, the computing device (e.g., system 200) that may be executing the method illustrated in FIG. 3 may provide one or more interfaces that are configured to allow an employee of the organization to create and/or access a referral for a particular customer (which may, e.g., allow such an employee to create a referral even if the CRM software used by their particular line of business does not independently provide such functionality).

In step 310, based on receiving the referral, the referral may be enriched by gathering available information about a customer associated with the referral. For example, in step 310, the computing device (e.g., system 200) may enrich the referral in response to receiving the referral from the source system (e.g., in step 305). In enriching the referral, the computing device may gather available information about a customer associated with the referral by accessing and/or obtaining various types of information from different systems and/or databases that may be maintained by and/or available to the financial institution. In particular, depending on the source line of business and/or the source CRM system, which may be referred to as a “pitching” system, enriching the referral may include gathering specific types of information that may be stored and/or maintained by the source line of business and/or the source CRM system about the customer associated with the referral. Because referrals may be received from different lines of business and source systems, including different source CRM systems, of an organization, the specific types of information that are gathered by the computing device in enriching the referral may vary depending on the source line of business and/or the source CRM system for each referral being handled and/or otherwise processed by the computing device.

In some embodiments, gathering available information about the customer may include collecting internal information about the customer's existing relationship with the organization. For example, in collecting internal information about the customer's existing relationship with the organization, the computing device (e.g., system 200) may access and/or obtain information about the customer's previously purchased, previously used, and/or currently used products and/or services. In instances in which the organization is a financial institution, collecting this internal information thus may include accessing and/or obtaining information about the customer's previous and/or current accounts. Additionally or alternatively, in collecting this internal information, the computing device may, for instance, access and/or obtained information from one or more databases and/or other systems that are used and/or maintained by the organization, which may, e.g., include account databases and/or transaction databases in instances in which the organization is a financial institution.

In step 315, a destination for the referral may be identified by processing the referral based on one or more business rules and one or more compliance requirements. For example, in step 315, the computing device may identify a destination for the referral by processing the referral based on one or more business rules and one or more compliance requirements. In some instances, the destination that may be identified in step 315 may include a specific line of business of an organization and/or a specific channel or group within such a line business.

Additionally or alternatively, the destination that may be identified in step 315 may include one or more specific CRM systems (which may, e.g., be referred to as a “catching” system) that may, for example, be used by such a line of business and/or a specific channel or group within a line of business.

For example, the one or more business rules and/or the one or more compliance requirements used in processing the referral in step 315 may specify whether a referral can be automatically routed to a specific individual, team, or system; may provide one or more criteria to be evaluated by the computing device in identifying a specific individual, team, or system to receive the referral; and/or may provide one or more other factors to be taken into account by the computing device in identifying a specific individual, team, or system to receive the referral. For instance, the one or more business rules may specify one or more rules and/or other criteria that are configured to cause the computing device to determine that a specific individual, team, or system should be identified as the destination for the referral based on the specific individual, team, or system being able to receive and handle the referral in a more efficient and/or lower cost manner relative to one or more other individuals, teams, and/or systems associated with the organization. Additionally or alternatively, the one or more compliance requirements may specify one or more rules and/or other criteria that are configured to cause the computing device to determine that a specific individual, team, or system should be identified as the destination for the referral so that a number of referrals being handled and/or managed by the computing device (e.g., system 200) may be distributed fairly and/or evenly among potential recipients of the referral (which may, e.g., include one or more financial advisors in instances in which the organization is a financial institution).

In some instances, the one or more compliance rules might only be taken into account by the computing device (e.g., system 200) when the referral is of a certain type and/or when the referral may potentially be routed to one or more specific lines of business (e.g., when the referral may potentially be routed to one or more specific lines of business that are primarily managed by and/or operated through a subsidiary of the organization, rather than being managed by and/or operated directly by the organization itself). In other instances, one or more reconciliation rules may be used by the computing device to resolve differences between the one or more business rules and the one or more compliance requirements. For instance, the one or more reconciliation rules may specify that the one or more compliance requirements trump the one or more business rules, such that the one or more compliance requirements are given a relatively higher priority by the computing device than the one or more business rules in identifying a destination for the referral.

In some instances, the destination for the referral that may be identified by the computing device in step 315 may be an automated assignment system. For example, in identifying a destination for the referral, the computing device may determine to route the referral to an automated assignment system, such as a “spinner” system. In instances where the organization is a financial institution, such a spinner system may, for example, be configured to automatically assign the referral to an individual financial advisor or a pool of financial advisors within a particular line of business of the organization and/or within a particular channel or group of such a line of business.

In other instances, the destination for the referral that may be identified by the computing device in step 315 may be a manual review team. For example, in identifying a destination for the referral, the computing device may determine to route the referral to a manual review team, such as an “enterprise client coverage” team. Such a manual review team may, for instance, be tasked with manually assigning specific referrals to specific individuals and/or teams for handling. For example, in instances where the organization is a financial institution, the manual review team may manually assign the referral to an individual financial advisor or a pool of financial advisors within a particular line of business of the organization and/or within a particular channel or group of such a line of business based on one or more predefined policies established by the organization.

In step 320, the referral may be routed to the identified destination. For example, in step 320, the computing device may route the referral to the destination identified in step 315. In routing the referral to the identified destination, the computing device (e.g., system 200) may, for instance, send and/or otherwise provide information associated with the referral to the identified destination and/or one or more computing devices and/or systems associated with the identified to facilitate further processing and/or follow-up on the referral. By processing and subsequently routing referrals in this way (and/or in accordance with one or more other aspects of the disclosure), a large organization, such as a financial institution, may, for example, be able to handle tens of thousands of referrals a month, while handling such referrals in the most efficient and cost-effective manner possible and also ensuring compliance with applicable regulatory requirements and other internal requirements.

In step 325, after routing the referral, the referral may be tracked. For example, in step 325, the computing device may track the referral (e.g., after routing the referral in step 320). In tracking the referral, the computing device may, for instance, periodically monitor the status of the referral. In some instances, the computing device may track multiple referrals that have been previously routed, and such tracking may, for instance, include reevaluating the status of any and/or all of these referrals on a periodic basis (e.g., hourly, daily, weekly, monthly, and/or the like).

In some embodiments, tracking the referral may include reassigning the referral if a referral recipient does not contact the customer within a predetermined amount of time. For example, in tracking the referral, the computing device may maintain one or more timers to measure the amount of time elapsed since the time when the referral was assigned to a recipient (e.g., a specific financial advisor or team of financial advisors, in some instances where the organization is a financial institution), and if the computing device does not receive an indication that the customer has been contacted within a predetermined amount of time (e.g., 48 hours) of the referral being assigned, the computing device may reassign the referral to another, different recipient (e.g., a different financial advisor or a different team of financial advisors, in some instances where the organization is a financial institution). In one or more arrangements, this time limit to contact a customer before a referral is reassigned might only be applied to certain referrals processed by the computing device (e.g., system 200), such as specific type(s) of referrals that may be assigned to one or more specific lines of business of the organization. In some arrangements, if a particular referral is reassigned three times without a recipient contacting the customer associated with the referral within the predetermined amount of time, the computing device may route the referral to the manual review team discussed above (e.g., for manual assignment of the referral to a financial advisor or team of financial advisors, in instances where the organization is a financial institution).

In some embodiments, tracking the referral may include maintaining expiration clock information associated with the referral. For example, in tracking the referral, the computing device may maintain expiration clock information associated with the referral, which may include creating and updating one or more timers that measure the time elapsed since the referral was created and/or may further include enforcing an expiration limit on the referral after a predetermined amount of time (e.g., 90 days) has elapsed. In enforcing such an expiration limit, the computing device may, for instance, cause the referral to expire after the predetermined amount of time has elapsed, such that the referral is no longer valid and the customer can no longer be contacted in connection within the referral (e.g., unless the customer gives new consent to be contacted in connection with the referral). In one or more arrangements, such an expiration limit (e.g., the 90-day expiration limit discussed in the example above) may apply to all referrals handled by the computing device (e.g., system 200) and/or created by the organization (e.g., regardless of the destination line of business and/or group or channel of the referral). Additionally or alternatively, consent information indicating that specific customers have consented to being contacted about specific products and/or services at specific times may be maintained globally across all lines of business of the organization in a central database that is deployed, maintained, and/or updated by the organization. Such a database may, for example, be included in and/or maintained by system 200. In some instances, the consent information may provide customer consent and/or authority to share information between different legal entities that may be associated with the organization. For example, the consent information maintained in the database may enable sharing of information about specific customers (who, e.g., have provided consent to such sharing of information) between a consumer banking legal entity and a brokerage legal entity.

In some embodiments, tracking the referral may include providing one or more status notifications to the source system. For example, in tracking the referral, the computing device (e.g., system 200) may provide one or more status notifications to the source system (which may, e.g., have created the referral and/or may have been used to create the referral by a specific individual or group). In some instances, the one or more status notifications may, for example, indicate whether the referral has been enriched, whether the referral has been routed to a specific destination, whether the referral has been assigned to a specific recipient associated with an identified destination, whether a customer associated with the referral has been contacted, and/or whether the customer has purchased any additional products and/or services as a result of the referral. In these ways, the person, group, and/or system that created and/or provided the referral may be updated as to the current status of the referral, as this may enhance the level of service that such a person, group, and/or system can provide to the customer associated with the referral.

In some embodiments, tracking the referral may include determining an amount of revenue generated by the referral. For example, in tracking the referral, the computing device (e.g., system 200) may determine an amount of revenue generated by the referral by identifying what, if any, products and/or services were purchased by the customer in connection with the referral. In instances in which the organization is a financial institution, tracking the referral thus may include determining if one or more accounts were opened and/or funded by the customer associated with the referral as a result of the referral. In some instances, this information may subsequently be used in generating one or more reports regarding the effectiveness of the referral program and/or the effectiveness and efficiency of the referral processing system (e.g., system 200).

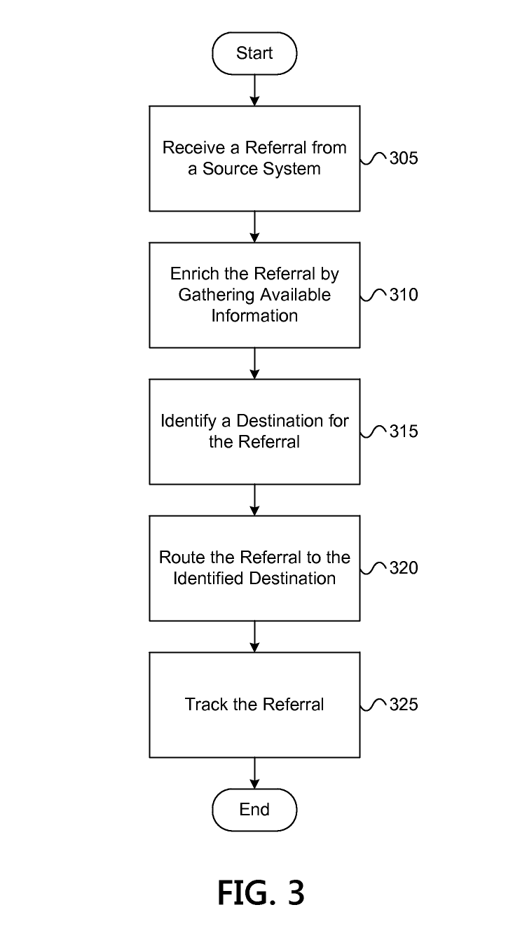

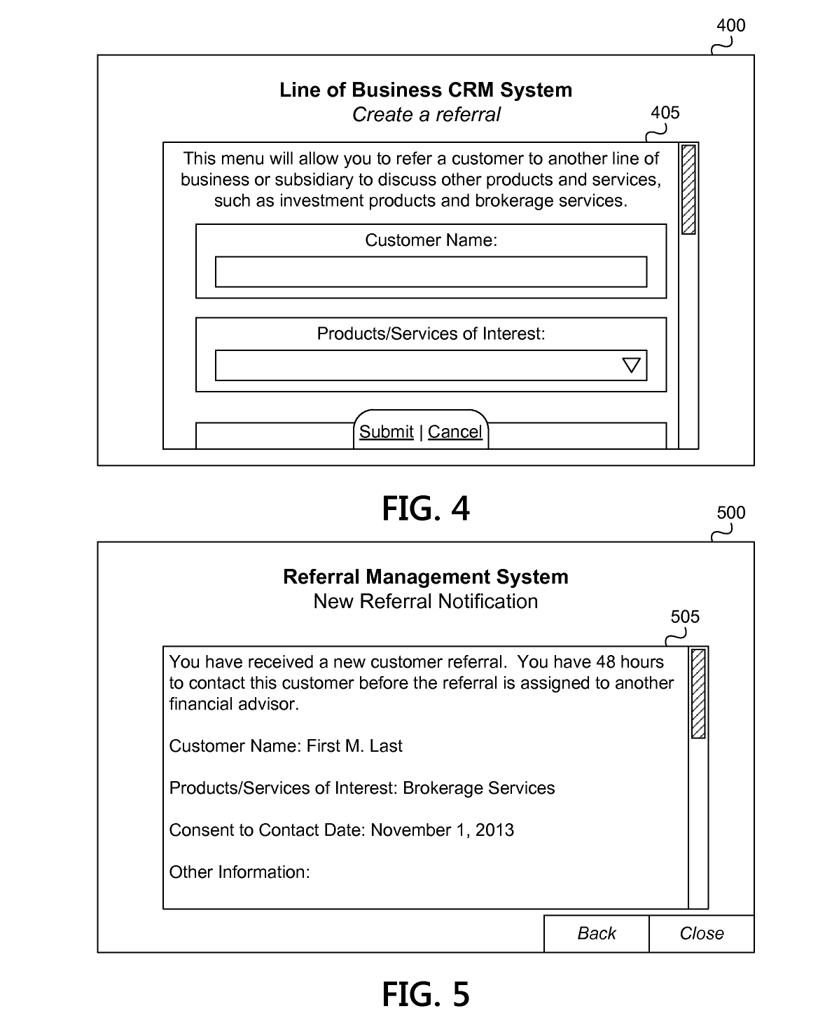

Having described several examples of the processing that may be performed in processing and routing referrals in some embodiments, several example user interfaces that might be displayed and/or otherwise provided by a computing device, such as a computing device implementing one or more aspects of computing device 101 and/or system 200, in performing such processing and/or in otherwise implementing various aspects of the disclosure will now be discussed with respect to FIGS. 4 and 5.

FIG. 4 illustrates an example of a user interface that may be displayed in creating and/or receiving a referral according to one or more aspects of the disclosure. As seen in FIG. 4, in some instances, a computing device implementing one or more aspects of the disclosure (e.g., computing device 101, system 200, and/or one or more other devices) may display and/or otherwise provide a user interface 400 that may allow a user to create a referral by entering information to define such a referral.

For example, user interface 400 may include an information box 405 that may include one or more text boxes (e.g., in which a user may be able to enter and/or select a customer name to define a customer associated with the referral being creating) and/or one or more other controls (e.g., in which a user may be able to enter and/or select one or more products and/or services that the customer may be interested in). By clicking “Submit,” the user may cause a computing device (e.g., system 200) to receive the referral, which may initiate the method discussed above with respect to FIG. 3.

FIG. 5 illustrates an example of a user interface that may be displayed in routing a referral according to one or more aspects of the disclosure. As seen in FIG. 5, in some instances, a computing device implementing one or more aspects of the disclosure (e.g., computing device 101, system 200, and/or one or more other devices) may display and/or otherwise provide a user interface 500 that may notify a user that a referral has been received for and/or assigned to the user.

For example, user interface 500 may include an information box 505 that may include information about a referral that has been received for and/or assigned to the user who may be interacting with user interface 500 (and who may, e.g., be a financial advisor in instances in which the organization is a financial institution). The information box 505 may, for instance, include information about a time limit in which the user must contact the customer before the referral is reassigned, various types of information about the customer, information about the products and/or services in which the customer may be interested, information about the date and/or time at which the customer consented to be contacted in connection with the referral, and/or other information.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable memory. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims are included in the scope of the present disclosure. For example, the steps illustrated in the illustrative figures may be performed in other than the recited order, and one or more steps illustrated may be optional in accordance with aspects of the disclosure.

What is claimed is:

1. A method, comprising:
receiving, by a computing device, a referral from a source system associated with a line of business of an organization;
based on receiving the referral, enriching, by the computing device, the referral by gathering available information about a customer associated with the referral;
identifying, by the computing device, a destination for the referral by processing the referral based on one or more business rules and one or more compliance requirements; and
routing, by the computing device, the referral to the identified destination.

2. The method of claim 1, wherein the source system is a customer relationship management (CRM) system used by the line of business in managing customer interactions.

3. The method of claim 1, wherein gathering available information about the customer includes collecting internal information about the customer's existing relationship with the organization.

4. The method of claim 1, wherein the identified destination is an automated assignment system.

5. The method of claim 1, wherein the identified destination is a manual review team.

6. The method of claim 1, further comprising:
after routing the referral to the identified destination, tracking, by the computing device, the referral.

7. The method of claim 6, wherein tracking the referral includes reassigning the referral if a referral recipient does not contact the customer within a predetermined amount of time.

8. The method of claim 6, wherein tracking the referral includes maintaining expiration clock information associated with the referral.

9. The method of claim 6, wherein tracking the referral includes providing one or more status notifications to the source system.

10. The method of claim 6, wherein tracking the referral includes determining an amount of revenue generated by the referral.

11. A computer system, comprising:
at least one processor; and
memory storing computer-readable instructions that, when executed by the at least one processor, cause the computer system to:
receive a referral from a source system associated with a line of business of an organization;
based on receiving the referral, enrich the referral by gathering available information about a customer associated with the referral;
identify a destination for the referral by processing the referral based on one or more business rules and one or more compliance requirements; and
route the referral to the identified destination.

12. The computer system of claim 11, wherein the source system is a customer relationship management (CRM) system used by the line of business in managing customer interactions.

13. The computer system of claim 11, wherein gathering available information about the customer includes collecting internal information about the customer's existing relationship with the organization.

14. The computer system of claim 11, wherein the memory stores additional computer-readable instructions that, when executed by the at least one processor, further cause the computer system to:
after routing the referral to the identified destination, track the referral.

15. The computer system of claim 14, wherein tracking the referral includes reassigning the referral if a referral recipient does not contact the customer within a predetermined amount of time.

16. The computer system of claim 14, wherein tracking the referral includes maintaining expiration clock information associated with the referral.

17. The computer system of claim 14, wherein tracking the referral includes providing one or more status notifications to the source system.

18. The computer system of claim 14, wherein tracking the referral includes determining an amount of revenue generated by the referral.

19. One or more non-transitory computer-readable media storing computer-executable instructions that, when executed, cause at least one computing device to:
receive a referral from a source system associated with a line of business of an organization;
based on receiving the referral, enrich the referral by gathering available information about a customer associated with the referral;
identify a destination for the referral by processing the referral based on one or more business rules and one or more compliance requirements; and
route the referral to the identified destination.

20. The one or more non-transitory computer-readable media of claim 19, wherein gathering available information about the customer includes collecting internal information about the customer's existing relationship with the organization.
